(19) United States
(12) Patent Application Publication
(10) Pub. No.: US 2025/0303340 A1
(43) Pub. Date: Oct. 2, 2025

(54) Apparatus for treating effluent gas stream

(71) Applicant: BHT SERVICES PTE. LTD., Kallang (SG)

(72) Inventor: Chee-Wei CHAN, Kallang (SG)

(21) Appl. No.: 19/090,713

(22) Filed: Mar. 26, 2025

Related U.S. Application Data
(60) Provisional application No. 63/570,941, filed on Mar. 28, 2024.

(51) Int. Cl. B01D 47/10

(52) U.S. Cl. CPC B01D 47/10

(57) ABSTRACT

An apparatus for treating effluent gas stream includes a main body and a separation unit. The main body includes a first inlet segment to receive a guiding fluid, a second inlet segment to receive an effluent from manufacturing processes, and a channel portion in fluid communication with the first and the second inlet segments. A dimensional difference is provided between the first inlet segment and the channel portion, such that when the guiding fluid flows from the first inlet segment into the channel portion, a centripetal suction is generated based on the dimensional difference. The separation unit includes a discharge portion connected downstream of the channel portion, defining a second flow path that follows a first flow path defined by the channel portion. The separation unit further includes a negative pressure source connected to the discharge portion and generating a reverse negative pressure to the second flow path.

### CROSS REFERENCE TO RELATED APPLICATIONS

This application claims priority of U.S. Provisional Application No. 63/570,941 filed on Mar. 28, 2024 under 35 U.S.C. § 119 (e), the entire contents of all of which are hereby incorporated by reference.

### FIELD OF THE INVENTION

The invention relates generally to the treatment of effluent gas stream. More particularly, the invention relates to an apparatus for separating solid particulate (e.g., dust, particles, or aerosols) from effluent gas stream, such as those encountered in semiconductor, display panel, solar cell, and other manufacturing processes.

### BACKGROUND OF THE INVENTION

Many manufacturing processes in industrial field—for example, in the fields of semiconductors, display panels, and solar cells-generate effluent gas stream containing various solid particles (e.g., dust, particulates, or fine powders). If such solid-phase pollutants are not properly removed or treated, the remaining chemical substances may harm human health and cause environmental pollution.

Conventional solutions for removing solid contaminants from gaseous exhaust streams include, for instance, the filtration-type separation modules disclosed in U.S. Pat. No. 8,657,942 B2 and U.S. Pat. No. 11,786,858. These modules rely on filter media that can separate vaporized liquids at specific locations from an effluent stream. However, filter-based approaches consume expendable materials (such as filter elements), thereby increasing cost and generating secondary waste.

Another conventional approach is the use of a combustion-type gaseous treatment module, as disclosed in U.S. Patent Publication No. 2005/0123461 A1. Although combustion-based modules may avoid the issue of consumable filter waste, they tend to have relatively complex structures with high manufacturing costs. They are also prone to damage and difficult to maintain.

Accordingly, there is a need for an apparatus that can effectively treat gaseous pollutants, particularly the solid-phase portion within gaseous streams. The apparatus should also avoid drawbacks such as complex structures or high consumable usage.

### SUMMARY OF THE INVENTION

This disclosure describes an apparatus and a system for treating effluent gas stream.

In some examples, the apparatus for treating an effluent gas stream comprises a main assembly and a separating section. The main assembly includes a first inlet portion configured to receive a fluid, a second inlet portion configured to receive an effluent from one or more processes, and a channel portion downstream in fluid communication with the first inlet portion and the second inlet portion. The first inlet portion and the channel portion are aligned along an axis and spaced apart. A dimensional difference is provided between the first inlet portion and the channel portion so as to induce a centripetal suction directed toward the axis and downward to the channel portion when the fluid passes from the first inlet portion into the channel portion. The separating section includes a discharge section connected to a downstream direction of the channel portion. The discharge section has an upstream end and a downstream end, defining a second flow path from the upstream end to the downstream end that follows a first flow path defined by the channel portion. The upstream end of the discharge section is connected to a negative pressure source which generates a negative pressure that is reversed with the second flow path. The fluid from the first inlet portion and the effluent from the second inlet portion enter the channel portion to form a mixed stream, the mixed stream is drawn out through the discharge section via the centripetal suction such that a liquid portion of the mixed stream is carried along the second flow path while a gaseous portion of the mixed stream is extracted by the negative pressure through a third flow path opposite to the second flow path.

In some examples, the apparatus for treating an effluent gas stream, comprises a first conduit, a second conduit, a third conduit and a negative pressure source. The first conduit is configured to receive a guiding fluid. The second conduit is positioned downstream from the first conduit and has an upstream end arranged in line with the first conduit and spaced from the first conduit. The second conduit receives an effluent from one or more processes at the upstream end. A dimensional difference is provided between the first conduit and the second conduit, such that when the guiding fluid flows from the first conduit into the second conduit, a centripetal suction directed toward the second conduit is generated. The third conduit is positioned downstream from the second conduit, the third conduit including a first discharge channel and a second discharge channel. The first discharge channel and the second discharge channel extends in different directions. The negative pressure source is connected to the first discharge channel of the third conduit. The guiding fluid and the effluent form a mixed stream, which is drawn by the centripetal suction and conveyed through the second conduit into the third conduit such that a liquid portion of the effluent is discharged along the second discharge channel and a gaseous portion of the effluent is extracted by a negative pressure generated by the negative pressure source along the first discharge channel.

### BRIEF DESCRIPTION OF THE DRAWINGS

Example embodiments of the present disclosure will be described with reference to the accompanying drawings briefly described below.

FIG. 1 is a schematic diagram illustrating an embodiment of the apparatus in connection with a reactor and a secondary scrubber.

FIG. 2 is a perspective view of a first embodiment of the apparatus.

FIG. 3 is a perspective sectional view taken along line A-A of FIG. 2.

FIG. 4 is a sectional view taken along line A-A of FIG. 2.

FIG. 5 is a perspective view of a second embodiment of the apparatus.

FIG. 6A is a perspective sectional view taken along line B-B of FIG. 5.

FIG. 6B is a perspective sectional view taken along line C-C of FIG. 5.

FIG. 7 is a sectional view taken along line B-B of FIG. 5.

### DETAILED DESCRIPTION

Prior to turning to the figures, which illustrate exemplary embodiments in detail, it should be understood that this disclosure is not limited to the specific details or methodologies described or shown in the figures. Additionally, the terminology used herein is for descriptive purposes only and should not be considered limiting.

Throughout the specification and claims, the meanings provided below are not intended to strictly limit the terms but to serve as illustrative examples. The terms “a,” “an,” and “the” should be understood to include plural references. The phrase “in an embodiment” or “in an example,” as used herein, does not necessarily refer to the same embodiment or example, although it may.

Many of the details, dimensions, angles and other features shown in the figures are merely illustrative of particular implementations. Accordingly, other implementations can have other details, components, dimensions, angles and features without departing from the spirit or scope of the present disclosure. In addition, further implementations of the disclosure can be practiced without several of the details described below.

In conventional gas abatement systems, an exhaust stream-even after passing through a reactor—may still contain solid particulate such as dust or micro-sized particles. These particles may deposit onto chamber or conduit walls, leading to performance reduction or blockages. Current solutions include manually scraping the deposits or using a filter to trap them. Both ways incur downtime, increase operating costs, or generate secondary waste.

Implementations disclosed herein include an apparatus or module capable of separating solid-phase particulate matter from an effluent gas stream from a processing chamber, such as a deposition chamber, an etch chamber or other vacuum processing chamber. Alternatively, the effluent gas stream may be from other manufacturing processing facility or a manufacturing process in the fields of semiconductors, display panels, or solar cells. In particular, the way that the apparatus or module disclosed herein separates the solid-phase particulate matter from the effluent gas stream may be described as fluid mechanics rather than chemical reaction or decomposition of the effluent gas stream, thereby reducing both energy consumption and operational costs typically associated with chemical-based treatment processes. In addition, the separation would be more efficient and reliable without involving chemical reactions.

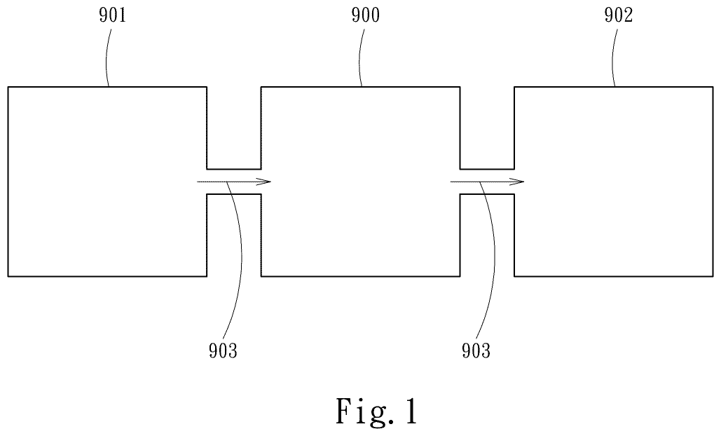

The apparatus or module may be used independently or integrated into a gas abatement system. For instance, as shown in FIG. 1, the treatment module 900 may be installed after a reactor 901 or before a wet scrubber 902 (such as a spray tower scrubber, a packed-bed scrubber, or a wet tank). Alternatively, the treatment module 900 may be installed between the reactor 901 and the wet scrubber 902. The module 900 receives an effluent 903 from the reactor 901 and then discharges into the downstream wet scrubber 902. In certain embodiments, the module may operate without external power except for a pump or an equivalent device for circulating the guiding fluid or generating negative pressure. The reactor 901 may be any type of combustion reactor, wet reactor, plasma combustion reactor, plasma gasification reactor, or thermal reactor, configured to abate exhaust gases from one or more processes. In one exemplary configuration, the module 900 functions as a pre-wet unit that separates solid particulate from the exhaust gases.

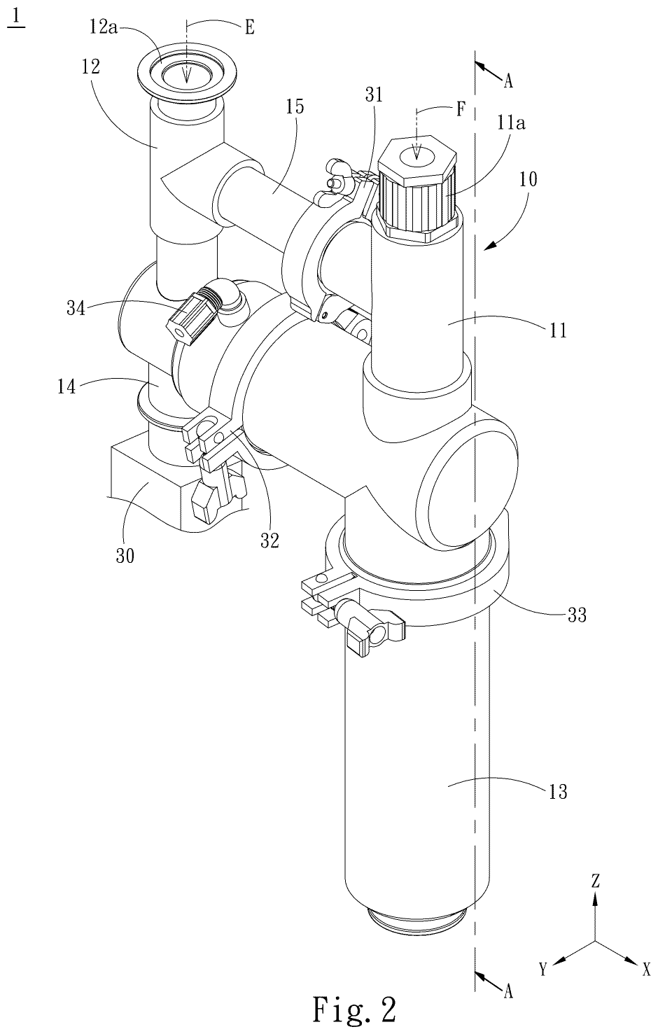

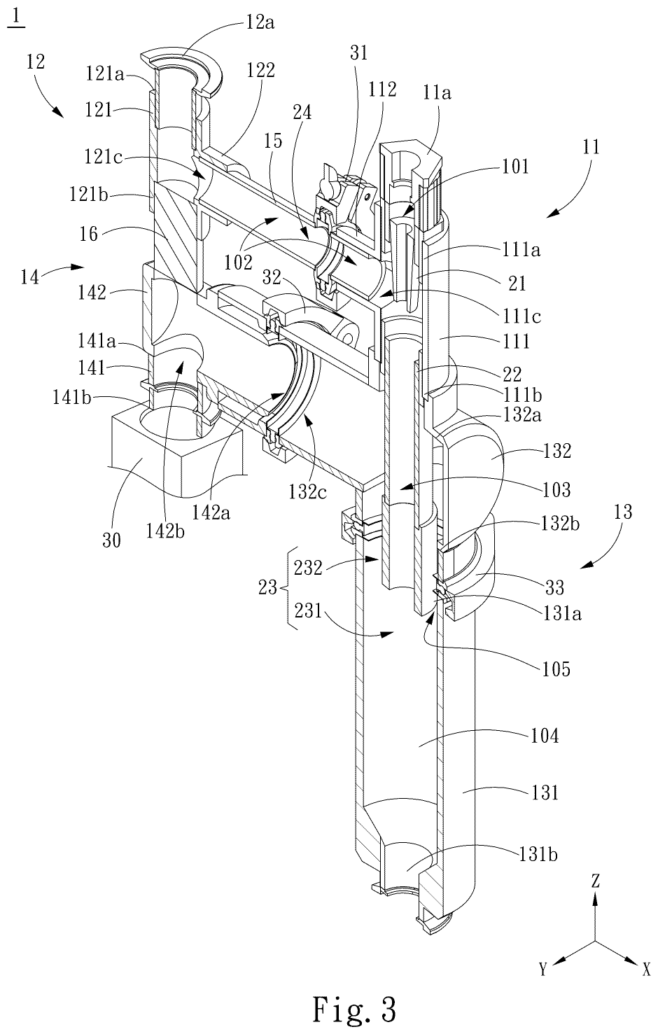

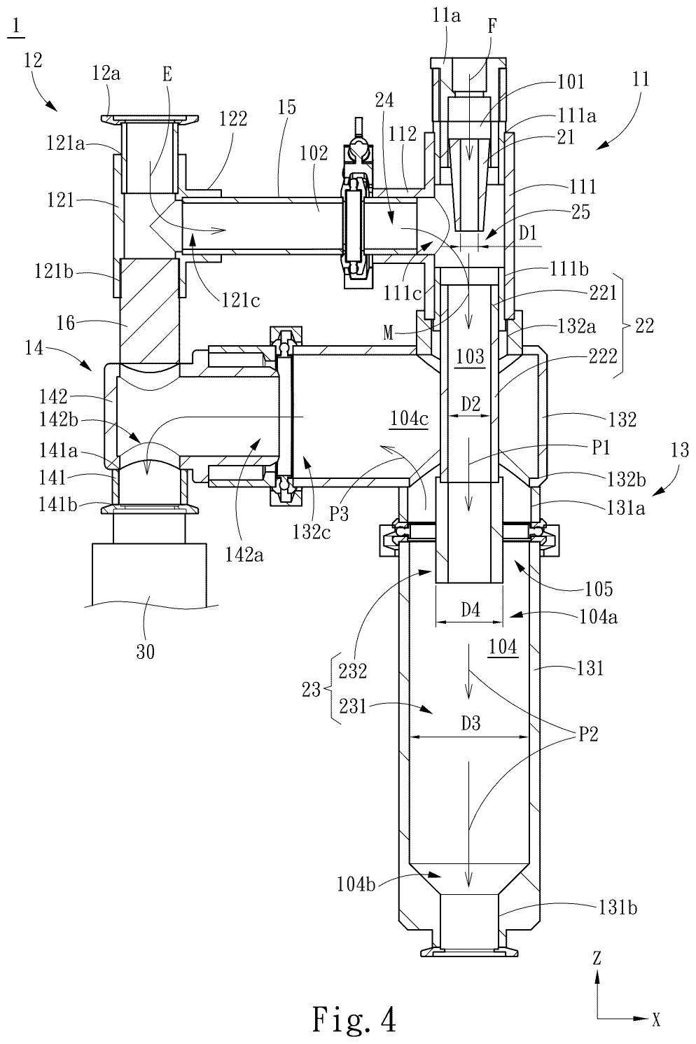

FIGS. 2 to 4 illustrate a first exemplary embodiment of an apparatus 1 for treating an effluent gas stream. The apparatus 1 comprises a main assembly 10, an internal conduit assembly, and a negative pressure source 30. The main assembly 10 may be considered as an “outer conduit assembly,” which manages inflow and outflow for both an effluent stream and a guiding fluid. The internal conduit assembly is disposed within the main assembly 10, and the negative pressure source 30 is positioned downstream from the main assembly 10.

In an example, the negative pressure source 30 may be a vacuum pump. The combination of the outer conduit assembly (the main assembly 10) and the internal conduit assembly effectuates separation of solid particulate substances from a mixed stream of the effluent stream and the guiding fluid.

The outer conduit assembly 10 includes a first portion 11, a second portion 12, a third portion 13, a fourth portion 14, and a transverse segment 15. The first portion 11 configured to receive and deliver a guiding fluid F, and the second portion 12 configured to receive and deliver an effluent E from one or more processes. In one example, the guiding fluid F is a liquid, such as water, and the effluent E is exhaust gas or effluent from a semiconductor manufacturing process that contains dust, particles, or particulates. The first portion 11, the second portion 12, the third portion 13, the fourth portion 14, and the transverse segment 15 are connected to form a chamber, and the internal conduit assembly is arranged within this chamber. The internal conduit assembly, together with the negative pressure source 30, serves as the separation portion of the apparatus 1 to separate gas and solids from the mixed stream of the guiding fluid F and the effluent E. In this embodiment, the first portion 11 and the second portion 12 are configured as an inlet, and the third portion 13 and the fourth portion 14 are configured as an outlet. It should be understood that the guiding fluid F is not the effluent to be treated, nor is it part of the effluent. Rather, the guiding fluid F is introduced so that the solids in the effluent E can be separated from the effluent E.

In this embodiment, a first coupling element 31 is used to join the first portion 11 and the second portion 12 in an end-to-end configuration, and a second coupling element 32 is used to join the third portion 13 and the fourth portion 14 in an end-to-end configuration.

In the first embodiment, the first portion 11 is a T-shaped, three-opening conduit that includes a vertical segment 111 extending in a vertical direction (the Z-direction) and a horizontal segment 112 extending in a horizontal direction (the X-direction). The vertical segment 111 includes a top opening 111a, a bottom opening 111b, and a lateral opening 111c located below the top opening 111a and above the bottom opening 111b. The lateral opening 111c of the vertical segment 111 is in fluid communication with the horizontal segment 112. The top opening 111a is provided with a connector 11a for coupling to a source of the guiding fluid F. The second portion 12 is also a T-shaped, three-opening conduit that includes a vertical segment 121 extending in the vertical direction and a horizontal segment 122 extending in the horizontal direction. The vertical segment 121 includes a top opening 121a, a bottom opening 121b, and a lateral opening 121c located below the top opening 121a and above the bottom opening 121b. The lateral opening 121c of the vertical segment 121 is in fluid communication with the horizontal segment 122. The top opening 121a is provided with a connector 12a for coupling to a source of the effluent E.

The third portion 13 includes a first connecting section 131 and a second connecting section 132, joined by a coupling element 33. The first connecting section 131 extends vertically, and the second connecting section 132 extends horizontally. The first connecting section 131 includes a top opening 131a and a bottom opening 131b. The second connecting section 132 includes a top opening 132a, a bottom opening 132b, and a lateral opening 132c. The top opening 132a of the second connecting section 132 is connected to the bottom opening 111b of the vertical segment 111 of the first portion 11. The top opening 131a of the first connecting section 131 is connected to the bottom opening 132b of the second connecting section 132, and the bottom opening 131b of the first connecting section 131 serves as a discharge port.

The fourth portion 14 includes a vertical segment 141 extending in the vertical direction and a horizontal segment 142 extending in the horizontal direction. The vertical segment 141 has a top opening 141a and a bottom opening 141b, while the horizontal segment 142 has a lateral opening 142a and a bottom opening 142b. The lateral opening 142a of the horizontal segment 142 is connected to the lateral opening 132c of the second connecting section 132 of the third portion 13. The vertical segment 141 is extended from the bottom opening 142b of the horizontal segment 142.

The first connecting section 131 of the third portion 13 and the vertical segment 111 of the first portion 11 are coaxially and end-to-end arranged, communicating with each other. The vertical segment 141 of the fourth portion 14 is also coaxially arranged with the vertical segment 121 of the second portion 12 but is spaced apart by a partition 16 so that they do not directly communicate.

In the main assembly 10, a part that receives and allows the guiding fluid F to flow through is defined as the first inlet segment 101, for example, an upstream portion of the vertical segment 111. A part that receives and allows the effluent E to flow through is defined as a second inlet segment 102, for example, the horizontal segment 112 or the first transverse segment 15. A part that receives a mixed stream M of the guiding fluid F and the effluent E is defined as a channel portion 103, and a part positioned downstream from the channel portion 103 is defined as a discharge portion 104.

In this embodiment, the vertical segment 111 of the first portion 11 can be divided into an upper region, a middle region, and a lower region. The guiding fluid F enters and flows through the upper region of the vertical segment 111, while the effluent E laterally enters from a side and flows through the middle region. The guiding fluid F and the effluent E meet and enter the lower region together, so the channel portion 103 may, for example, be the lower region of the vertical segment 111 or a portion downstream of the lower region of the vertical segment 111.

The first inlet segment 101 and the channel portion 103 are aligned in the same vertical direction and spaced apart from each other. The second inlet segment 102 extends horizontally toward a region between the first inlet segment 101 and the channel portion 103, allowing the guiding fluid F and the effluent E to converge downstream of the first inlet segment 101 and the second inlet segment 102 and to enter the channel portion 103. The first inlet segment 101 is located in the vertical segment 111 of the first portion 11, and the second inlet segment 102 is located in the horizontal segment 112 of the first portion 11. The channel portion 103 maybe partly located within the vertical segment 111.

The internal conduit assembly is disposed within the chamber and includes a first conduit 21, a second conduit 22, a third conduit 23, and a fourth conduit 24. The first conduit 21 is configured to receive the guiding fluid F and has a dimensional difference relative to the second conduit 22 in terms of opening diameter. The first conduit 21 may be arranged within the vertical segment 111 of the first portion 11. In this embodiment, an outer wall of the first conduit 21 is tapered downward in a conical shape for convenient installation, and an interior of the first conduit 21 may be a straight tubular form. The second conduit 22 is positioned downstream from the first conduit 21. As shown in the figures, a portion 221 of the second conduit 22 lies within the vertical segment 111 of the first portion 11, while another portion 222 passes through the second connecting section 132 of the third portion 13 (from the top opening 132a to the bottom opening 132b) and extends as far as the first connecting section 131 of the third portion 13. The second conduit 22 is fitted into the bottom opening 111b of the vertical segment 111 of the first portion 11 so that the top opening 132a of the second connecting section 132 and the bottom opening 111b of the vertical segment 111 of the first portion 11 are connected but not in direct fluid communication.

The second conduit 22 is arranged coaxially with the first conduit 21 and spaced apart, allowing the guiding fluid F to merge with the effluent E. In other words, the second conduit 22 and the first conduit 21 communicate but are neither directly or physically connected, so there is a space 25 between a top of the second conduit 22 and a bottom of the first conduit 21.

The fourth conduit 24 is configured to receive the effluent E and communicates laterally with the space 25. The fourth conduit 24 may be the horizontal segment 112 and/or the first transverse segment 15 of the first portion 11, such that the effluent E merges with the guiding fluid F in the space 25 and flows downward into the second conduit 22. In some cases, the first conduit 21 may be designated as a first inlet portion and the fourth conduit 24 may be designated as a second inlet portion. In other cases, the upper region of the vertical segment 111 may be designated as the first inlet portion, the horizontal segment 112 of the first portion 11 may be designated as the second inlet portion.

A dimensional difference is provided between the first conduit 21 and the second conduit 22 (that is, there is a dimensional difference between the first inlet segment 101 and the channel portion 103) to create a pressure differential guidance effect, inducing a centripetal suction that directs the guiding fluid F toward the channel portion 103 along the axis as the guiding fluid flows from the first inlet portion into the channel portion 103.

When the guiding fluid F flows from the first conduit 21 into the second conduit 22, the dimensional difference induces a centripetal suction directed toward the second conduit 22, guiding the effluent E to flow into the second conduit 22 and merge with the guiding fluid F. In this embodiment, a diameter D1 of the first conduit 21 is smaller than a diameter D2 of the second conduit 22.

Accordingly, the first inlet segment 101 that receives and allows the guiding fluid F to flow through can be viewed as a passage defined by the first conduit 21. The channel portion 103 that receives the mixed stream of the guiding fluid F and the effluent E can be seen as a passage defined by the second conduit 22. A dimensional difference is provided between the first inlet segment 101 and the channel portion 103. The passage of the first inlet segment 101 has a diameter smaller than the passage of the channel portion 103. In addition, the second inlet segment 102 that receives and allows the effluent E to flow through can be seen as a passage defined by the fourth conduit 24, which brings the effluent E laterally to the region that is between the channel portion 103 and an outlet end of the first inlet segment 101.

The third conduit 23 is connected downstream of the second conduit 22 and may be the second connecting section 132 of the third portion 13, or a combination of the first connecting section 131 and the second connecting section 132 of the third portion 13. In this embodiment, the third conduit 23 includes a first discharge channel 231 and a second discharge channel 232, both communicating downstream of the second conduit 22. In this embodiment, a diameter D3 of the first connecting section 131 of the third portion 13 is greater than a diameter D4 of the second conduit 22, and the bottom opening 132b of the second connecting section 132 of the third portion 13 is also larger than the diameter D4 of the second conduit 22.

However, the diameter D4 of the second conduit 22 is close or approximately equal to that of the bottom opening 111b of the vertical segment 111 of the first portion 11 so as to fit into the bottom opening 111b.

Thus, the third portion 13 may define out two fluid passages: one fluid passage is a portion of the first connecting section 131 extending downward from a bottom end of the second conduit 22 (the first discharge channel 231), and another fluid passage is a portion of the first connecting section 131 extending upward from the bottom end of the second conduit 22 to the second connecting section 132 (the second discharge channel 232). The first discharge channel 231 and the second discharge channel 232 extend in different directions, that is, one downward and one upward.

In one example, the third conduit 23 may be considered as the discharge portion 104. The first discharge channel 231 and the second discharge channel 232 extend in parallel but opposite directions. The diameter (D3) of the discharge portion 104 is larger than the diameter (D4) of the channel portion 103 (namely, the passage defined by the second conduit 22), and the discharge portion 104 extends in line with the channel portion 103 and positioned downstream from the channel portion 103. The discharge portion 104 includes a first end 104a near the channel portion 103 and a second end 104b opposite the first end 104a. An annular passage 105 is formed between the first end 104a of the discharge portion 104 and the channel portion 103, and the annular passage 105 is connected to the negative pressure source 30. In this embodiment, the second discharge channel 232 can additionally be equipped with a connector 34, which may be provided on the horizontal segment 142 of the fourth portion 14. The connector 34 can be coupled to a source of liquid so that liquid can be introduced into the second discharge channel 232 to flush out residual material within the chamber.

The first end 104a of the discharge portion 104 is an upstream end, and the second end 104b is a first downstream end. The discharge portion 104 also has a second downstream end 104c corresponding to the annular passage 105. The discharge portion 104 defines a second flow path P2 from the upstream end 104a to the first downstream end 104b, following a first flow path P1 defined by the channel portion 103. The negative pressure source 30 is connected to the upstream end 104a of the discharge portion 104 and generates a reversed negative pressure in the second flow path P2. The effluent E is guided by the centripetal suction (caused by the dimensional difference between the first inlet segment 101 and the channel portion 103) and enters the channel portion 103 together with the guiding fluid F, then is discharged through the discharge portion 104. At least part of the liquid phase in the effluent E is discharged with the guiding fluid F along the second flow path P2, while at least part of the non-liquid phase is extracted by the negative pressure and discharged along a third flow path P3 opposite to the second flow path P2.

The second conduit 22 defines the first flow path P1 of the guiding fluid F. The guiding fluid F flows from the first inlet segment 111 along the first flow path P1 through the channel portion 103. The effluent E is constrained by the partition 16 and travels through the horizontal segment 122, the first transverse segment 15, and the horizontal segment 112 toward the second inlet segment 102 and the channel portion 103, causing the guiding fluid F and the effluent E to merge in the channel portion 103. The guiding fluid F and the effluent E continue along the first flow path P1 toward the third conduit 23. The discharge portion 104 extends from the upstream end 104a to the downstream end 104b to define a second flow path P2, which follows the first flow path P1.

In this embodiment, the negative pressure source 30 is placed at a terminal end of the fourth portion 14 and is connected to the discharge portion 104. More specifically, the negative pressure source 30 is connected to the upstream end 104a of the discharge portion 104 and generates a reversed negative pressure in the second flow path P2.

In the example, the apparatus 1 is vertically oriented relative to the ground, that is, the XY plane is parallel to the ground. When the effluent E is directed by the centripetal suction to flow together with the guiding fluid F into the channel portion 103, the effluent E and the guiding fluid F form the mixed stream M, which is drawn by the centripetal suction to be discharged through the discharge portion 104. Based on the structure of this embodiment, the discharge portion 104 extends vertically downward—for instance, along the vertical direction or along the plumb line or gravitational direction. Thus, a liquid portion of the mixed stream M naturally flows out through the bottom opening 131b of the first connecting section 131 under the influence of gravity, while a gas portion of the mixed stream M is extracted by the negative pressure and moves upwardly along the third flow path P3, which is opposite to the second flow path P2. In the present example, the annular passage 105 defines the third flow path P3, and the gas portion ultimately exits from the bottom opening 141b of the fourth portion 14. The bottom opening 141b of the fourth portion 14 may be connected to a downstream wet scrubber.

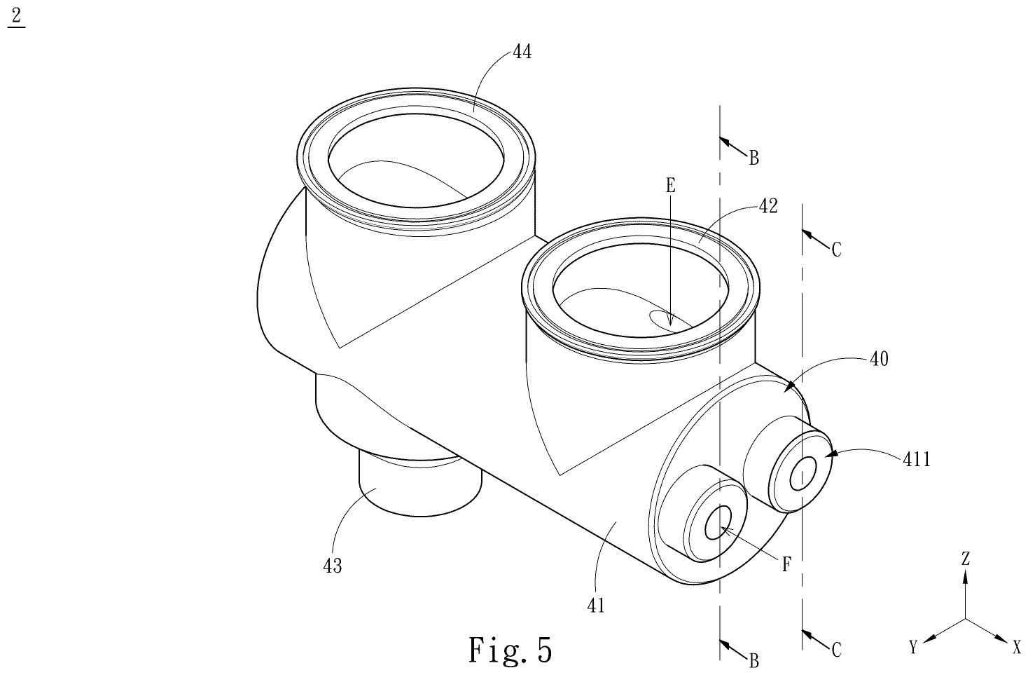

It should be understood that the liquid portion of the mixed stream M may not necessarily include all of the liquid phase in the mixed stream M. It might include most of it or only part of it. Solid substances (such as dust, particles, or particulates) or water-soluble gaseous in the effluent E will exit along with that liquid portion through the second flow path P2, while water-insoluble gases in the effluent E will exit along the third flow path P3 with the gas portion. Consequently, solid-phase separation of the effluent is achieved, effectively removing residual solid matter in the effluent E, particularly micro-particulates such as PM 2.5. Furthermore, the gas portion may still contain residual liquid (e.g., water) or solid matter, so a demister or the like can be installed on the third flow path P3 to remove such residues. In some examples, the term “negative pressure source 30” is not meant to indicate a specific, tangible hardware component. Instead, it may refer to any mechanism or feature within the apparatus that is capable of generating negative pressure. For instance, the negative pressure function might be provided indirectly, such as by a pump located downstream of the scrubber, rather than by a physical component in the apparatus 1 for drawing gas. As long as the features capable of accomplishing gas extraction or generating negative pressure are provided in the apparatus 1, it is sufficient. That is, the apparatus 1 may not require a pump in some examples. For instances, the pump in the downstream scrubber may provide such features to the apparatus 1. In terms of the operation, the apparatus 1 may require only a pump, or potentially no pump at all to function as a device for separating solid substances from the effluent, thus neither an external power source nor mechanical drive is required. The flow discharged from the second opening 141b of the fourth portion 14 can be regarded as effluent that has undergone solid-phase separation, which continues to be treated by the wet scrubber. FIG. 5 shows a second embodiment of the present invention. The apparatus 2 for treating gaseous pollutants includes a main assembly 40 and a negative pressure source, where the main assembly 40 includes a first portion 41, a second portion 42, a third portion 43, and a fourth portion 44. The negative pressure source is connected with the fourth portion 44. The first portion 41 configured to receive and deliver a guiding fluid F, and the second portion 42 configured to receive and deliver an effluent E.

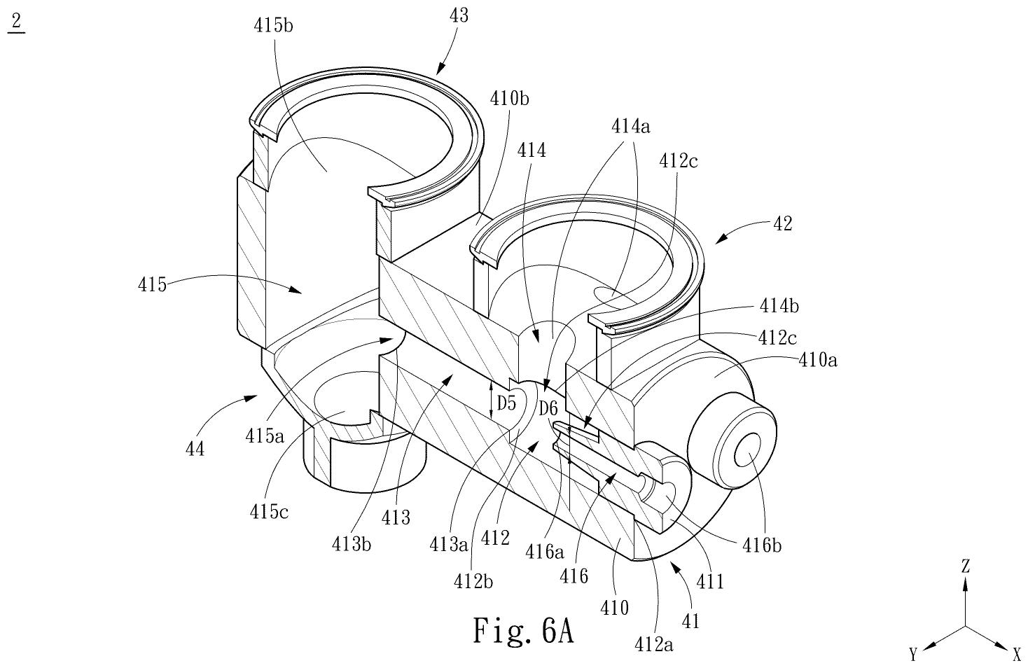

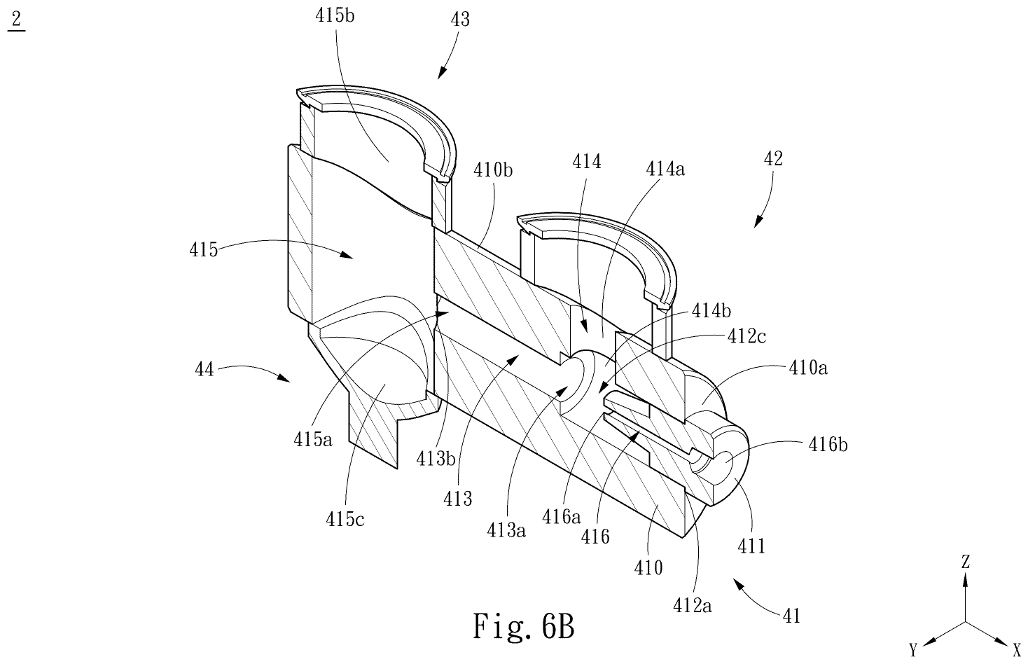

Referring to FIGS. 6A and 6B, the first portion 41 of the main assembly 40 includes a horizontally aligned tubular body 410 extending in the horizontal direction and at least one guiding element 411 attached to the tubular body 410. The tubular body 410 has at least one first through-hole 412, at least one second through-hole 413, at least one third through-hole 414, and a fourth through-hole 415. The first through-hole 412 and the second through-hole 413 are arranged end-to-end along the horizontal direction, and the third through-hole 414 is arranged vertically. The first through-hole 412 passes through a front end face 410a of the tubular body 410 and extends rearward into an interior of the tubular body 410, while the second through-hole 413 extends rearward from a tail end of the first through-hole 412 to a front side of the fourth through-hole 415. The third through-hole 414 passes through an outer circumferential surface 410b of the tubular body 410 and extends to a side of the first through-hole 412.

Thus, the first through-hole 412, the second through-hole 413, and the third through-hole 414 collectively form a T-shaped three-way conduit. A first flow inlet 412a of the first through-hole 412 receives the guiding fluid F, and a second flow inlet 413a of the second through-hole 413 receives the effluent E via the second portion 42. The diameter of the first through-hole 412 is larger than the inside diameter D5 of the second through-hole 413, thereby conveniently accommodating insertion of the guiding element 411 into the first flow inlet 412a. The guiding element 411 has a fifth through-hole 416, including a fifth flow outlet 416a positioned coaxially with the second flow inlet 413a of the second through-hole 413 and apart from the second flow inlet 413a of the second through-hole 413. The fifth flow outlet 416a has a diameter D6 smaller than a diameter D5 of the second through-hole 413, thereby forming a dimensional difference. The guiding fluid F enters from the fifth flow inlet 416b of the fifth through-hole 416.

The third flow inlet 414a of the third through-hole 414 is arranged on the outer circumferential surface 410b of the tubular body 410, and the third flow outlet 414b of the third through-hole 414 lies on an inner wall 412c of the first through-hole 412, positioned after the first flow outlet 412b of the first through-hole 412 and before the second flow inlet 413a of the second through-hole 413. This arrangement allows the guiding fluid F and the effluent E to merge between the first flow outlet 412b and the second through-hole 413. The fourth through-hole 415 has a fourth flow inlet 415a, a first opening 415b, and a second opening 415c. The first opening 415b is provided on a top side of the outer circumferential surface 410b of the tubular body 410, and the fourth through-hole 415 extends vertically through the tubular body 410 and the second opening 415b is located on a bottom side of the outer circumferential surface 410b. The fourth flow inlet 415a is communicated with the second flow outlet 413b of the second through-hole 413.

The first opening 415b and the second opening 415c of the fourth through-hole 415 are respectively used as flow outlets, and either the first opening 415b or the second opening 415c may be connected to the negative pressure source.

The second portion 42, the third portion 43, and the fourth portion 44 are each sleeve-shaped structure. The second portion 42 is disposed on the third flow outlet 414b of the third through-hole 414 and connects to a source of the effluent E. The third portion 43 is disposed on the first opening 415b of the fourth through-hole 415 and connects to a downstream wet scrubber and/or the negative pressure source, and the fourth portion 44 is disposed on the second opening 415c of the fourth through-hole 415.

In the main assembly 40, a part that receives and delivers the guiding fluid F is defined as a first inlet segment 401 (for example, the fifth through-hole 416 of the guiding element 411). The part that receives and delivers the effluent E is defined as a second inlet segment 402 (for example, the third through-hole 414). The part that receives and delivers the mixed stream M of the guiding fluid F and the effluent E is defined as a channel portion 403 (for example, the second through-hole 413). The part connected downstream rof the channel portion 403 is defined as a discharge portion 404 (for example, the fourth through-hole 415).

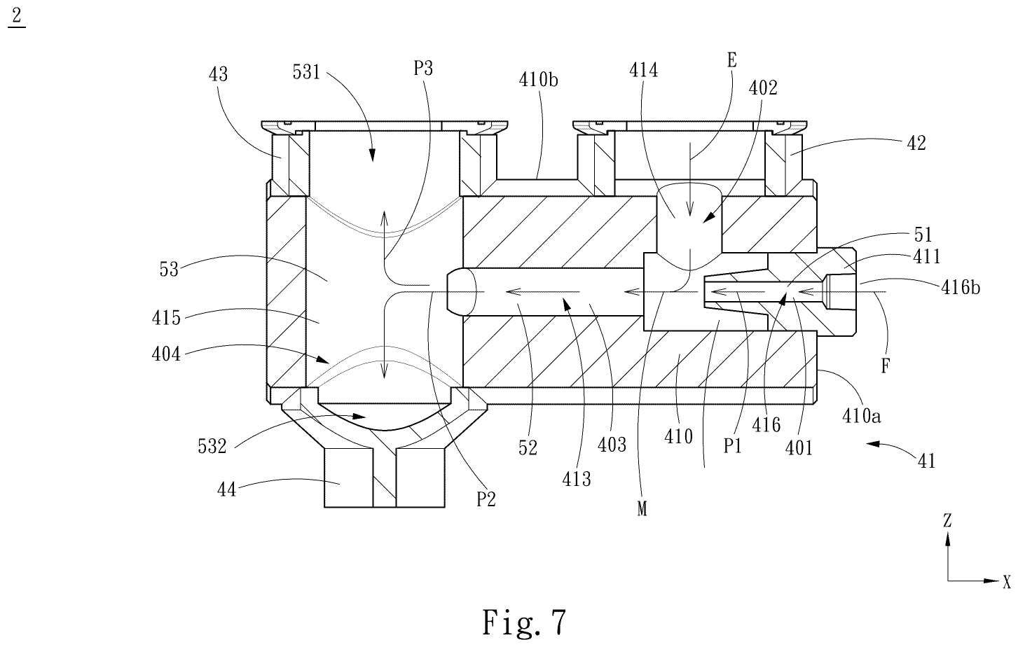

On the other hand, the apparatus 2 may be construed as having multiple conduits, such as a first conduit 51, a second conduit 52, and a third conduit 53, as shown in FIG. 7. The first conduit 51 may be the fifth through-hole 416 of the guiding element 411 and is used to receive the guiding fluid F.

The second conduit 52 may be the second through-hole 413, located downstream of the first conduit 51, with its upstream end arranged in line with but spaced from the first conduit 51. The second conduit 52 receives the effluent E from an upstream end, and there is a dimensional difference between the first conduit 51 and the second conduit 52. When the guiding fluid F flows from the first conduit 51 into the second conduit 52, the dimensional difference induces a centripetal suction toward the second conduit 52. The third conduit 53 may be the second through-hole 413 situated downstream of the second conduit 52.

The third conduit 53 includes a first discharge channel 531 and a second discharge channel 532, which extend in different directions. The negative pressure source may connect to either the first discharge channel 531 or the second discharge channel 532. Assuming the negative pressure source is connected to the first discharge channel 531, the effluent E is guided by the centripetal suction and enters the third conduit 53 together with the guiding fluid F through the second conduit 52, at least part of the liquid phase of the effluent E being discharged along the second discharge channel 532 with the guiding fluid, and at least part of the non-liquid phase of the effluent E being extracted by the negative pressure source along the first discharge channel 531.

Referring to FIG. 7, the second conduit 22 (the channel portion 403) defines the first flow path P1 of the guiding fluid F. The guiding fluid F flows from the first inlet segment 401 along the first flow path P1 through the channel portion 403. The effluent E flows from the second inlet segment 402 to the channel portion 403, causing the guiding fluid F and the effluent E to merge in the channel portion 403. The guiding fluid F and the effluent E continue flow along the first flow path P1 to the third conduit 53 (the discharge portion 404), and a second flow path P2 is defined between an upstream end and a downstream end of the discharge portion 404, following the first flow path P1.

In this embodiment, the negative pressure source is connected to the upstream end of the discharge portion 404 and generates a reversed negative pressure on the second flow path P2. When the effluent E is drawn by the centripetal suction to flow together with the guiding fluid F into the channel portion 403 and is discharged from the discharge portion 404, at least part of the liquid phase of the effluent E is carried with the guiding fluid F along the second flow path P2 from the third portion 43. Because gravity influences the discharge portion 403 along the vertical direction, the second flow path P2 runs downward, and at least part of the non-liquid phase of the effluent E is extracted by the negative pressure and discharged along a third flow path P3 opposite to the second flow path P2, toward the fourth portion 44.

By virtue of the design in this embodiment, the discharge portion 404 extends downward from top to bottom, for instance, along the vertical direction or the plumb line or gravity direction. Consequently, a liquid portion of the mixed stream M naturally flows out through the second opening 415c of the fourth through-hole 415 in the fourth portion 44 under the influence of gravity, while a gas portion of the mixed stream M is extracted by the negative pressure and moves in a direction (upward direction) opposite to the second flow path P2, namely along the third flow path P3.

In some examples, the term “negative pressure source” is not meant to indicate a specific, tangible hardware component. Instead, it may refer to any mechanism or feature within the apparatus that is capable of generating negative pressure. For instance, the negative pressure function might be provided indirectly-such as by a pump located downstream of the scrubber—rather than by a physical component in the apparatus 2 for extracting gas. As long as the features capable of accomplishing gas extraction or generating negative pressure are provided in the apparatus 2, it is sufficient. That is, the apparatus 2 may not require a pump in some examples. For instances, the pump in the downstream scrubber may provide such features to the apparatus 2. In terms of the operation, the apparatus 2 may require only a pump, or potentially no pump at all to function as a device for separating solid substances from the effluent, thus neither an external power source nor mechanical drive is required. The flow discharged from the second opening 415c of the fourth portion 44 can be regarded as effluent that has undergone solid-phase separation, which continues to be treated by the wet scrubber.

1. An apparatus for treating an effluent gas stream, comprising:
a main assembly, including a first inlet portion configured to receive a fluid, a second inlet portion configured to receive an effluent from one or more processes, and a channel portion downstream in fluid communication with the first inlet portion and the second inlet portion, wherein the first inlet portion and the channel portion are aligned along an axis and spaced apart, a dimensional difference is provided between the first inlet portion and the channel portion so as to induce a centripetal suction directed toward the axis and downward to the channel portion when the fluid passes from the first inlet portion into the channel portion; and
a separating section, including a discharge section positioned downstream from the channel portion, the discharge section having an upstream end and a downstream end, defining a second flow path from the upstream end to the downstream end that follows a first flow path defined by the channel portion, wherein the upstream end of the discharge section is connected to a negative pressure source which generates a negative pressure that is reversed with the second flow path;
wherein the fluid from the first inlet portion and the effluent from the second inlet portion enter the channel portion to form a mixed stream, the mixed stream is drawn out through the discharge section via the centripetal suction such that a liquid portion of the mixed stream is carried along the second flow path while a gaseous portion of the mixed stream is extracted by the negative pressure through a third flow path opposite to the second flow path.

2. The apparatus of claim 1, wherein water-insoluble gas-phase and solid-phase substances in the effluent are discharged together with the gaseous portion along the third flow path.

3. The apparatus of claim 1, wherein a diameter of the first inlet portion is smaller than a diameter of the channel portion.

4. The apparatus of claim 1, wherein a tail end of the first inlet portion and a head end of the channel portion are arranged coaxially and spaced apart along an axial direction.

5. The apparatus of claim 1, wherein the second inlet portion is oriented laterally so as to guide the effluent to a region between the channel portion and an outlet end of the first inlet portion.

6. The apparatus of claim 1, wherein the first inlet portion and the second inlet portion extend in mutually orthogonal directions.

7. The apparatus of claim 1, wherein a diameter of the discharge section is greater than a diameter of the channel portion, the discharge section extending in a direction following a downstream direction of the channel portion and comprising a first end adjacent the channel portion and a second end opposite the first end, an annular passage defining the third flow path being provided between the first end of the discharge section and the channel portion, the annular passage being connected to the negative pressure source.

8. The apparatus of claim 1, wherein the discharge section comprises an inlet in communication with the channel portion and a first conduit and a second conduit each communicating with the inlet, the first conduit and the second conduit extending in different directions.

9. A system for treating gaseous pollutants, comprising:
the apparatus of claim 1; and
a reactor connected to the apparatus.

10. The system of claim 9, wherein the reactor is a combustion reactor, a wet reactor, a plasma combustion reactor, a plasma gasification reactor, or a thermal reactor, configured to abate exhaust gases from one or more processes.

11. An apparatus for treating an effluent gas stream, comprising:
a first conduit configured to receive a guiding fluid;
a second conduit positioned downstream from the first conduit, the second conduit having an upstream end arranged in line with the first conduit and spaced from the first conduit, the second conduit receiving an effluent from one or more processes at the upstream end, a dimensional difference being provided between the first conduit and the second conduit, such that when the guiding fluid flows from the first conduit into the second conduit, a centripetal suction directed toward the second conduit is generated;
a third conduit positioned downstream from the second conduit, the third conduit including a first discharge channel and a second discharge channel, the first discharge channel and the second discharge channel extending in different directions; and
a negative pressure source connected to the first discharge channel of the third conduit;
wherein the guiding fluid and the effluent form a mixed stream, the mixed stream being drawn by the centripetal suction and conveyed through the second conduit into the third conduit, a liquid portion of the effluent being discharged along the second discharge channel, and a gaseous portion of the effluent being extracted by a negative pressure generated by the negative pressure source along the first discharge channel.

12. The apparatus of claim 11, wherein water-insoluble gas-phase and solid-phase substances in the effluent are discharged along a third flow path together with the gas portion.

13. The apparatus of claim 11, wherein a diameter of the first conduit is smaller than a diameter of the second conduit.

14. The apparatus of claim 11, wherein a tail end of the first conduit and a head end of the second conduit are arranged coaxially and spaced apart.

15. The apparatus of claim 11, further comprising a fourth conduit that is oriented laterally so as to guide the effluent to a region between the second conduit and an outlet end of the first conduit.

16. The apparatus of claim 15, wherein the fourth conduit and the second conduit extend in mutually orthogonal directions.

17. The apparatus of claim 11, wherein a diameter of the third conduit is greater than a diameter of the second conduit, the third conduit extending in a direction following a downstream direction of the second conduit and comprising a first end adjacent the second conduit and a second end opposite the first end, an annular passage defining the first discharge channel being provided between the first end of the third conduit and the second conduit, the annular passage being connected to the negative pressure source.
